(19) United States
(12) Patent Application Publication
(10) Pub. No.: US 2026/0086598 A1
(43) Pub. Date: Mar. 26, 2026

(54) POWER-EFFICIENT CLOCK GENERATOR WITH INTEGRATED CLOCK GATING LOGIC

(71) Applicant: Morse Micro Pty. Ltd., Surry Hills NSW (AU)

(72) Inventor: Tomas Kubec, Surry Hills NSW (AU)

(21) Appl. No.: 19/261,968

(22) Filed: Jul. 7, 2025

(30) Foreign Application Priority Data
Sep. 26, 2024 (AU) 2024903103

(51) Int. Cl. G06F 1/08; G06F 1/10

(52) U.S. Cl. CPC G06F 1/08; G06F 1/10

(57) ABSTRACT

A clock generator with built-in clock gating logic comprises sub-dividers, multiplexers, and a clock selection controlling clock gate logic. The sub-dividers receive and divide an input clock to generate divided clocks. The multiplexers receive a control signal and coupled to the sub-dividers to receive the divided clock, and it outputs a selected clock according to the control signal as an output clock. Each multiplexer is arranged to receive two input clocks and generate one output clock according to a select signal. The clock selection controlling clock gate logic receives the internal states from the multiplexers and generates selection signals for the sub-divider accordingly. Each of the sub-dividers is ungated or gated depending on the corresponding selection signal output from the clock selection controlling clock gate logic.

### CROSS REFERENCE TO RELATED APPLICATION

The present application claims priority from Australian provisional patent application number 2024903103 filed on 26 Sep. 2024, the contents of which are incorporated herein by cross-reference.

### FIELD OF THE INVENTION

The present disclosure generally relates to digital circuit design. Specifically, aspects of the present disclosure are related to digital clock dividers for multiple clock domains in digital circuits.

### BACKGROUND

Most modern digital systems require multiple clock signals to operate various subsystems and modules efficiently. These digital systems often include components such as digital processors, communication peripherals, and memory interfaces that function optimally at different clock frequencies. For instance, a Phase-Locked Loop (PLL) might generate a high-frequency clock signal, such as 192 MHz, but this frequency may be too high for certain parts of the system, like external flash memory or slower peripheral modules. It is common practice to derive several lower-frequency clocks from a single high-frequency clock source to satisfy the diverse timing requirements across a system.

Rather than relying on multiple external oscillators, which are costly in terms of area and power, digital clock dividers are used to generate the required lower-frequency clocks. A clock divider reduces the frequency of an input clock signal by an integer factor, producing output clocks that are synchronized but slower than the input clock signal. These clock dividers are essential for implementing flexible, low-power clocking strategies in modern SoCs and embedded systems. Firmware can dynamically control clock dividers to scale down clock frequencies when full-speed operation is unnecessary, thereby reducing power consumption.

Clock dividers can be implemented using various digital logic techniques. One of the simplest and most common methods is the use of toggle flip-flops. A divide-by-2 clock divider, for example, can be created using a single D-type flip-flop (DFF) with feedback from the inverted output to the input, toggling on each rising edge of the clock signal. For further division, cascaded flip-flops can form binary counters where each flip-flop divides the clock frequency by two. These clock divider designs are easy to implement and highly efficient.

More complex clock dividers can be built using counters that reset after a programmable number of clock cycles. For example, a counter that toggles its output every N input clock cycles can create a divide-by-2N clock. This approach allows for greater flexibility in generating non-binary clock division ratios. Another method involves the use of Johnson counters, which are a type of shift register that cycles through a sequence of states, offering predictable timing patterns useful for clock division and phase generation.

A clock generator with integrated clock dividers is one of the key building blocks in digital systems, enabling multiple synchronized clock domains with varying frequencies derived from a single clock source. This enhances design flexibility, supports power-saving strategies, and simplifies system integration by minimizing the need for multiple external clock sources.

### SUMMARY

The following summary presents technical features relating to one or more aspects of disclosed herein and should not be considered as an extensive overview relating to all contemplated aspects. Accordingly, the following summary has the sole purpose of presenting certain concepts relating to one or more embodiments relating to a clock generator disclosed herein in a simplified form to precede the detailed description presented below.

Embodiments of the clock generator with built-in clock gating logic include sub-dividers, multiplexers, and a clock selection controlling clock gate logic for receiving an input clock and generating an output clock according to a control signal. The sub-dividers divide the input clock to generate divided clocks. The multiplexers receive the divided clocks and output a selected clock according to the control signal as the output clock. Each multiplexer is arranged to receive two input clocks and generate one output clock according to a select signal, and each multiplexer outputs internal states indicating the input clocks being active or inactive. Some embodiments of the select signals are derived from the control signal. The two input clocks of each multiplexer are selected from the input clock, the divided clocks output from the sub-dividers, and the output clocks of other multiplexers. The clock selection controlling clock gate logic receives the internal states from the multiplexers and generates selection signals for the sub-dividers according to the internal states. Each of the sub-dividers is ungated or gated depending on the corresponding selection signal output from the clock selection controlling clock gate logic.

In some embodiments, the input clock of each multiplexer is active when the input clock is being selected by the select signal to propagate to the output clock of the multiplexer. The control signal determines the select signal for each multiplexer to propagate the selected clock from the sub-divider to the output clock. Some embodiments of the multiplexer include a double synchronizer, allowing switching between two asynchronous or synchronous input clocks without glitches. An embodiment of the double synchronizer includes two stages of flip flops.

In some embodiments, one or more of the sub-dividers in the clock generator is configured to generate multiple divided clocks based on multiple predefined division rates. The clock selection controlling clock gate logic generates a selection signal for each of the divided clocks sharing the same sub-divider according to one embodiment, where the shared sub-divider is gated or ungated according to a logically combined selection signal derived from the selection signals. In another embodiment, the clock selection controlling clock gate logic generates a selection signal for the multiple divided clocks sharing the same sub-divider.

For example, the clock selection controlling clock gate logic receives the internal states output from one of the multiplexers indicating a first input clock is being active while the second input clock is being inactive. In response, the clock selection controlling clock gate logic generates a selection signal to gate the sub-divider generating the second input clock and generates a selection signal to ungate the sub-divider generating the first input clock.

The clock selection controlling clock gate logic generates a selection signal to ungate the sub-divider generating the selected clock when the received internal states indicate the corresponding input clock of every multiplexer needed for propagating the selected clock is active. In another example, the clock selection controlling clock gate logic generates a selection signal to gate one of the sub-dividers generating a divided clock when the received internal states indicate any input clock of the multiplexers needed for propagating the divided clock is inactive.

In some embodiments, the clock selection controlling clock gate logic ungates one or more sub-dividers according to the internal states during a transition period of clock switching initiated according to the control signal. The output clock of the clock generator becomes a new selected clock after the transition period of clock switching. In one embodiment, the output clock of the clock generator is temporarily halted during the transition period of clock switching. The clock selection controlling clock gate logic only ungates the sub-divider generating the new selected clock while gating all other sub-dividers after the transition period of clock switching. Some embodiments of the clock selection controlling clock gate logic ungates multiple sub-dividers to enable multiple divided clocks during the transition period of clock switching, the transition period is terminated when only one sub-divider is ungated.

In some embodiments of the present invention, the input clock of the clock generator is a high-speed clock generated by a Phase Locked Loop (PLL) and the output clock of the clock generator is a clock source for a digital module.

One aspect of the present invention is a clock generating method with clock gating for a digital circuit. The clock generating method includes receiving an input clock and a control signal, dividing the input clock by a first sub-divider of multiple sub-dividers to generate a selected clock determined by the control signal, propagating the selected clock through one or more multiplexers to output the selected clock, determining one or more selection signals for the sub-dividers according to internal states of the multiplexers, and ungating the first sub-divider generating the selected clock while gating all other sub-dividers according to the one or more selection signals. The one or more multiplexers is controlled by the control signal. The internal states of the one or more multiplexers indicate input clocks being active or inactive.

In some embodiments, the clock generating method further includes dividing the input clock by a second sub-divider to generate a new selected clock, controlling the one or more multiplexers to propagate the new selected clock, determining the one or more selection signals for the sub-dividers according to update internal states of the one or more multiplexers, ungating more than one sub-divider according to the updated internal states of the one or more multiplexers during a transition period of clock switching, and ungating only the second sub-divider while gating all other sub-dividers after the transition period of clock switching. An embodiment of the clock generating method halts outputting any clock during the transition period of clock switching.

Other objects and advantages associated with the aspects disclosed herein will be apparent to those skilled in art based on the accompanying drawings and detailed description.

### BRIEF DESCRIPTION OF THE DRAWINGS

Illustrative aspects of the present application are described in detail below with reference to the following drawing figures:

FIG. 1 illustrates a block diagram of a clock generator with selectable sub-dividers.

FIG. 2 illustrates a block diagram of an internal structure of a glitch-free multiplexer according to an embodiment of the present invention.

FIG. 3 illustrates an embodiment of the clock generator with integrated clock gating logic applied to multiple sub-dividers.

FIG. 4 provides a signal path example for enabling a divde-by-3 clock by ungating only the corresponding sub-divider in accordance with an embodiment of the present invention.

FIG. 5 illustrates another embodiment of the clock generator with built-in clock gating logic.

### DETAILED DESCRIPTION

Certain aspects and embodiments of this disclosure are provided below. Some of these embodiments may be applied independently and some of them may be applied in conjunction as would be apparent to those of skill in the art. In the following description, for the purposes of explanation, specific details are set forth to provide a thorough understanding of aspects of the application. However, it will be apparent that various embodiments may be practiced without these specific details. The following description of the embodiments will provide those skilled in the art with an enabling description for implementing an example aspect. Changes may be made in the function and arrangement of elements without departing from the spirit and scope of the application as set forth in the claims.

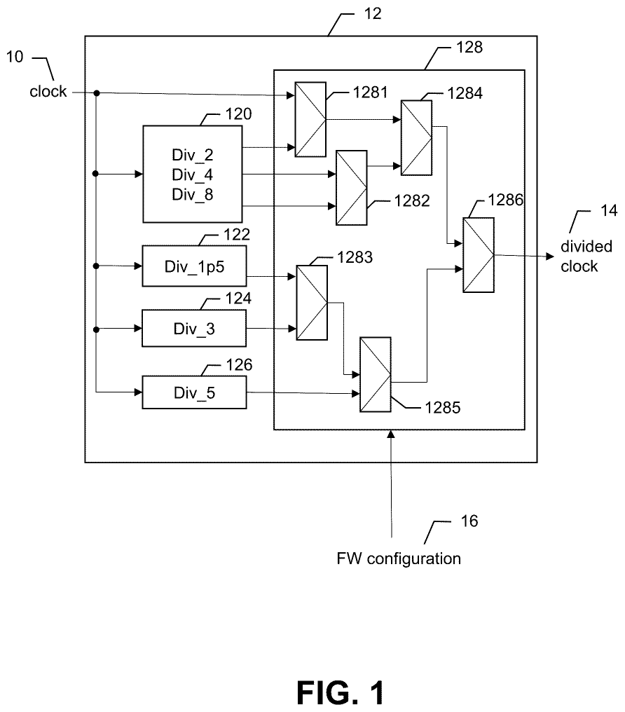

Each of the digital modules in a complex system with various clock domains may have a dedicated clock divider to divide a high-speed clock down to a clock with a desired frequency. An example of the complex system is an Integrated Circuit (IC), such as a System on Chip (SoC) or Application Specific Integrated Circuit (ASIC) including multiple subsystems or modules. The modules may be operated at different clock rates and the clock rates are switchable during operation. The desired frequency for a digital module may be adaptively determined by the firmware or software setting. The clock divider is also referred to as a clock generator in this specification. The integrated circuit described herein includes a clock generator instantiating a set of individual sub-dividers. Each sub-divider divides a high-speed input clock, for example, a 192 MHz clock generated from a PLL, by a different ratio to produce a corresponding lower-frequency output. The outputs of these sub-dividers are multiplexed using glitch-free multiplexers based on the firmware configuration and traced out for the logic downstream. FIG. 1 illustrates a block diagram of a clock generator 12 that can divide an input clock 10 down to a divided clock 14 with a slower clock frequency. The clock generator 12 is also referred to as a clock generator in this specification. As shown in FIG. 1, supported division ratios include 2, 4, 8, 1.5, 3, and 5, and a division ratio for dividing the high-speed input clock is selected from the supported division ratios according to a control signal FW configuration 16. Four sub-dividers 120, 122, 124, and 126 slow down the input clock 10 according to the corresponding division ratios. The outputs of these sub-dividers together with the input clock 10 are fed to multiple multiplexers 128. Multiplexers 1281, 1282, 1283, 1284, 1285, and 1286 are glitch-free multiplexers, each allows the output to switch between two synchronous clock inputs. Regardless of the division ratio selected, all the sub-dividers 120, 122, 124, and 126 within the clock generator 12 keep toggling at high-speed input clock frequency, including those sub-dividers corresponding to division ratio(s) not selected, leading to unnecessary power consumption. This inefficiency becomes more severe as these clock generators are instantiated many times. Additionally, switching between clock domains or frequencies must be handled carefully to avoid signal glitches, which can compromise the functionality or reliability of the system.

Embodiments of a power efficient clock generator with built-in clock gating logic are developed to reduce power waste. The built-in clock gating logic takes the divider ratio configuration into account, which enables the high-speed input clock to only input to the sub-dividers that are actively used based on the divider ratio configuration, while all other unused sub-dividers are clock gated.

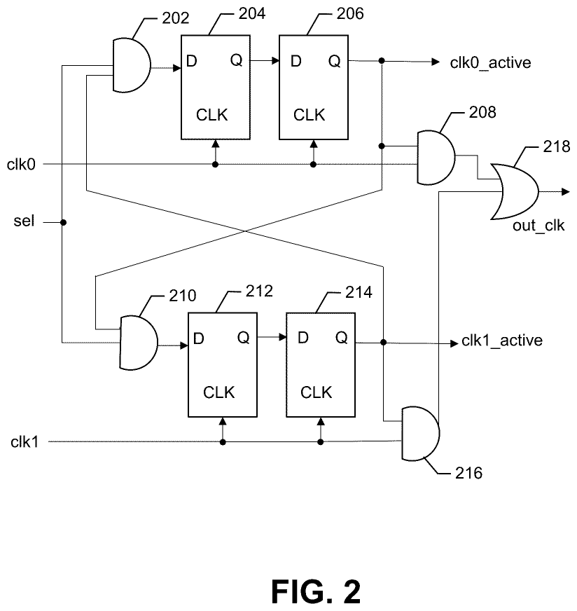

Each glitch-free multiplexer in the clock generator is a building block that allows the output to switch between two synchronous clocks without producing glitches. FIG. 2 illustrates an embodiment of an internal structure of a glitch-free multiplexer used in a clock generator that enables seamless clock switching. The glitch-free multiplexer takes two input clocks, clk0 and clk1, along with a select signal sel, to generate an output clock out_clk. The glitch-free multiplexer generates the output glitch-free clock by propagating the input clock clk0 when the select signal is low (i.e., sel=0), and the propagating the input clock clk1 when the select signal is high (i.e., sel=1). The glitch-free multiplexer as shown in FIG. 2 is composed of AND gates 202, 208, 210, and 216, flip flops 204, 206, 212, and 214, and an OR gate 218. In some embodiments, the select signal sel for each glitch-free multiplexer in the clock generator is determined or derived by the control signal FW configuration 16 as shown in FIG. 1. The glitch-free multiplexer includes a double synchronizer to mitigate potential metastability caused by asynchronous transitions. An embodiment of the double synchronizer is simply two stages of flip flops as shown in FIG. 2, where the first stage helps stabilize data by latching it and later passing it onto the next stage to be interpreted by the rest of the circuit. The glitch-free multiplexer keeps track internally of each input clock being active or inactive and outputs two internal states clk0_active and clk1_active. In response to the select signal sel, the internal state clk0_active is set high indicating the corresponding input clock clk0 is selected to propagate to the output clock out_clk, and the internal state clk1_active is set high indicating the corresponding input clock clk1 is selected to propagate the output clock out_clk. The output clock out_clk reflects the selected input clock without generating glitches. Embodiments of the multiplexer generate internal states (clk0_active and clk1_active) that indicate which input clock is currently active and propagated to the output. These internal states are used by the clock gating logic to determine which sub-divider to enable according to embodiments of the present invention.

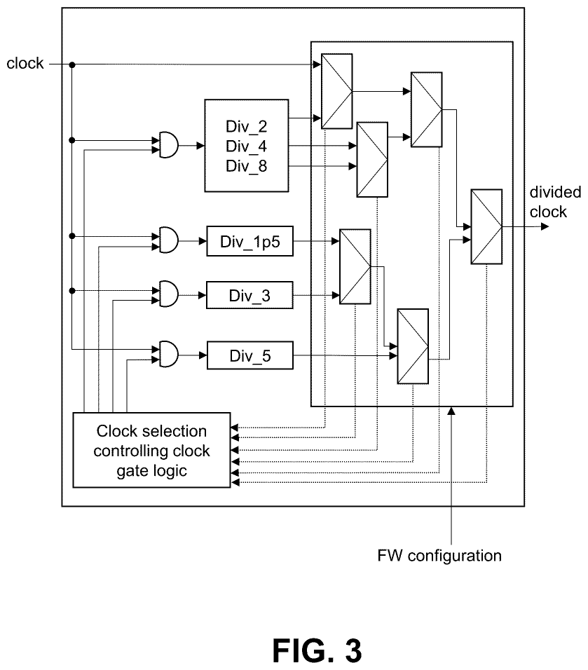

FIG. 3 illustrates an embodiment of a clock generator having built-in clock gating logic to reduce the power consumption of the clock divider. In this embodiment, the clock generator receives a high-speed input clock, for example a clock output from a PLL. In this embodiment, the clock generator includes four sub-dividers, where each sub-divider corresponds to a division ratio or it may share multiple division ratios. For example, divide-by-2, divide-by-4, and divide-by-8 clocks share a single sub-divider as shown in FIG. 3. The second sub-divider divides the high-speed input clock by 1.5 to generate a divide-by-1p5 clock, the third sub-divider divides the high-speed input clock by 3 to generate a divide-by-3 clock, and the fourth sub-divider divides the high-speed input clock by 5 to generate a divide-by-5 clock. In an example, for a 192 MHz input clock, the clock generator incorporating these four sub-dividers can selectively output a divided clock running at 96 MHz, 48 MHz, 24 MHz, 128 MHz, 64 MHz, or 38.4 MHz depending on the control signal FW configuration.

Referring to FIG. 3, a clock selection controlling clock gate logic receives a set of two internal states clk0_active and clk1_active from each glitch-free multiplexer, where each dashed line represents one set of two internal states. The clock selection controlling clock gate logic generates a selection signal for controlling each sub-divider depending on the internal states of the glitch-free multiplexers. The selection signals output from the clock selection controlling clock gate logic are also referred to as clock enable pins in this specification. In various embodiments, each selection signal can be used to gate or ungate a corresponding sub-divider, or it can be used to enable or disable a corresponding clock signal propagating through the clock generator. This clock gating mechanism ensures that only the sub-divider associated with the selected clock is active. The clock selection controlling clock gate logic takes information from all the multiplexers to ungate (i.e., enable) one of the sub-dividers and gate (i.e., disable) the remaining sub-dividers by outputting a clock enable pin to each sub-divider. The clock selection controlling clock gate logic is responsive to the sets of internal states output by the glitch-free multiplexers and enables only the sub-divider corresponding to the selected clock output. Other sub-dividers in the clock generator are gated to prevent unnecessary toggling, significantly reducing power consumption. In some embodiments, the clock selection controlling clock gate logic is configured to output a set of selection signals corresponding one-to-one with the set of divided clocks that the clock generator can generate. For example, the clock selection controlling clock gate logic outputs three selection signals corresponding to the divide-by-2, divide-by-4, and divide-by-8 clocks respectively. In cases when a shared sub-divider is used for these three divided clocks, the shared sub-divider is enabled when any of the three selection signals indicates the corresponding divided clock is selected. For example, these three selection signals are logically combined to control the shared sub-divider, and the clock selection controlling clock gate logic enables or disables the shared sub-divider according to the logically combined selection signal. In some other embodiments, the number of selection signals is equal to the number of sub-dividers in the clock generator. In the embodiment as shown in FIG. 3, the shared sub-divider shared among the divide-by-2 clock, divide-by-4 clock, and divide-by-8 clocks receives a single selection signal from the clock selection controlling clock gate logic, and this selection signal being asserted when the selected clock corresponds to any of these three divided clocks. As a result of sharing a sub-divider among multiple divided clocks, the total number of selection signals, that is the number of clock enable pins, can be reduced. For example, the number of clock enable pins coupled between the clock selection controlling clock gate logic and the sub-dividers is reduced from six to four in this embodiment.

Since the firmware control signal (i.e., the control signal FW configuration) exist in a different clock domain than the sub-dividers of the clock generator, direct usage of the firmware control signal for gating the sub-dividers is avoided. Instead, the internal states, clk0_active and clk1_active, output from the glitch-free multiplexers are used to drive the clock selection controlling clock gate logic according to embodiments of the present invention. The internal states are the resynchronized version of the control signal that are in the same clock domain as the clock generator. This ensures safe and reliable operation of the clock selection controlling clock gate logic for clock gating of the unused sub-dividers.

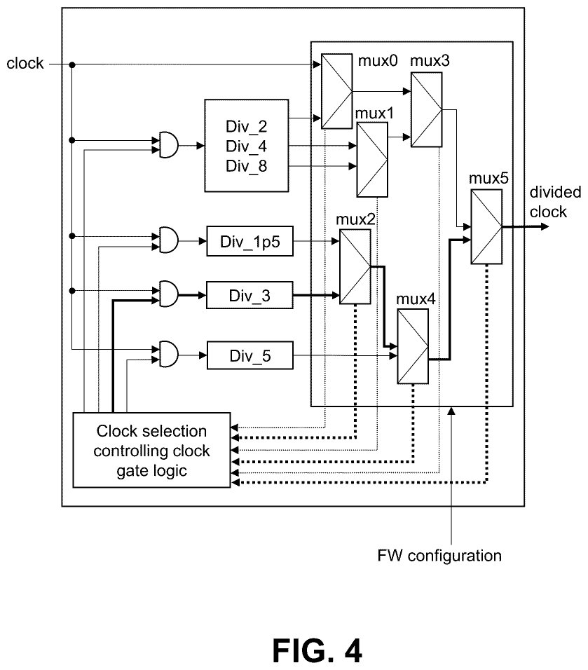

In some embodiments of the present invention, the clock selection controlling clock gate logic is configured to enable a selected clock while gating all other clocks, based on the internal states of the set of glitch-free multiplexers required to propagate the selected clock. FIG. 4 illustrates an embodiment where the clock generator is configured to enable the divide-by-3 clock. In this example, the divide-by-3 sub-divider is ungated when the internal states of the multiplexers indicate that mux2 asserts clk1_active, mux4 asserts clk0_active, and mux5 asserts clk1_active. Under these conditions, the clock selection controlling clock gate logic gates all remaining sub-dividers to disable all other clocks. During a clock switching event, where the selection signals provided to the multiplexers through the sub-dividers are updated to select a new clock output, there exists a transition period in which the internal states of the multiplexers may not yet fully reflect the new clock selection. This transition period results from inherent differences in propagation delays and clock domains between the various multiplexers. Consequently, one portion of the multiplexers may transition to the new state faster than another portion, potentially leading to a temporary condition in which no valid clock is output. To mitigate this glitch window during the transition, some embodiments of the clock selection controlling clock gate logic monitor the transition condition by detecting when the new selection signal remains de-asserted while the previous selection signal is also de-asserted, thereby indicating an ongoing clock switching operation. In response to detecting this transition condition, the clock selection controlling clock gate logic ungates the sub-divider associated with the new clock selection in advance of full propagation through the multiplexers, thereby ensuring continuity of clock output during the transition period. In some embodiments, the clock selection controlling clock gate logic may ungate one or more sub-dividers whose associated multiplexers are in an indeterminate (inactive) state before settling to the new clock selection. As a result, multiple sub-dividers may be temporarily ungated during the clock switching process, potentially causing one or more unintended clocks to be enabled transiently. This transitional state is tolerated by the system in order to guarantee a continuous and glitch-free output clock throughout the clock switching sequence. In some embodiments, the clock selection controlling clock gate logic takes care of short overlapping periods of time during switching from one clock rate to another due to uneven clock frequencies for several clock periods before settling to the new clock rate.

In an exemplary embodiment, a clock generator incorporates multiple sub-dividers, glitch-free multiplexers (GFMs), and a clock selection controlling clock gate logic. The clock generator receives a high-frequency input clock and selectively outputs one of the high-frequency input clock and several divided clocks based on a multi-bit clock selection control signal. This control signal may be programmed via firmware or software according to some embodiments. An example of the clock selection control signal is the control signal FW configuration as shown in FIG. 3. Upon a transition of the clock selection control signal, for example, from a value of ‘0’ selecting the high-frequency input clock to a value of ‘6’ selecting a divide-by-5 clock, the clock gating logic initiates a transition period of clock switching, during which one or more sub-dividers may become simultaneously active, as multiple clock selection signals are temporarily asserted. In response to this clock rate update and based on the internal states output from the GFMs, the clock selection controlling clock gate logic sequentially enables a number of clocks before settling to the new clock rate. For example, the clock selection controlling clock gate logic first enables the divide-by-1p5 clock, divide-by-3 clock, divide-by-4 clock, and divide-by-8 clock. Subsequently, it enables the divide-by-2 clock and disables the divide-by-3 clock. After several cycles of the high-speed input clock, the clock selection controlling clock gate logic enables the divide-by-5 clock while disabling the divide-by-2, divide-by-4, and divide-by-8 clocks. The divide-by-1p5 clock is then disabled, thereby leaving only the divide-by-5 clock propagating to the output. A short transition period is required for the GFMs to settle to the new clock selection, during which multiple clocks may be temporarily enabled. During this transition period, the GFMs are stabilizing to the new clock selection, and multiple sub-divider clocks may begin toggling. To ensure glitch-free operation, the clock generator output is temporarily halted during the transition period until the clock gating logic confirms that only the newly selected clock is propagating through the GFMs according to an embodiment. Once the system verifies that all unintended clocks are gated off and the selected clock is stable, the clock generator output resumes toggling at the correct output frequency. This mechanism prevents propagation of invalid or spurious clock edges during clock rate transitions, thereby ensuring reliable and deterministic clock switching behavior.

In the example of FIG. 4, the clock selection controlling clock gate logic determines that the new clock may correspond to the divide-by-3 clock when the internal states of mux2, mux4, and mux5 indicate that both clk0_active and clk1_active signals are inactive. Under this condition, the clock selection controlling clock gate logic enables the divide-by-3 clock by ungating the corresponding sub-divider. In an embodiment, the clock selection controlling clock gate logic may temporarily ungate one or more other sub-dividers under these conditions. For example, the sub-divider for the divide-by-1p5 clock may also be ungated, as the divide-by-1p5 clock shares portions of the signal propagation path with the divide-by-3 clock. Consequently, the clock selection controlling clock gate logic may interpret the inactive states of mux2, mux4, and mux5 as potentially corresponding to either the divide-by-3 clock or the divide-by-1p5 clock, resulting in both clocks being temporarily enabled during the transition period. In this embodiment, the clock selection controlling clock gate logic enables the divide-by-3 clock when the internal state of mux2 indicates that clk1_active is asserted or that both clk0_active and clk1_active are inactive; mux4 indicates that clk0_active is asserted or that both clk0_active and clk1_active are inactive; and mux5 indicates that clk1_active is asserted or that both clk0_active and clk1_active are inactive. In some embodiments, a multiplexer having both indicators clk0_active and clk1_active low indicates a transition phase between clock sources. In a stable state, one of these indicators is high while the other is low, signifying which clock is currently active. It is ambiguous which clock will become active at the moment when both are low. To ensure continuous operation, both clock sources are temporarily enabled during this transition according to this embodiment. Once the clock switching completes and only one indicator asserts high, the clock generator finalizes the switching by keeping the corresponding clock active and disabling the other. The enabling of other divided clocks by the clock selection controlling clock gate logic follows the same principle.

In another example of sequential clock switching in a clock generator having multiple sub-dividers from a divide-by-1p5 clock to divide-by-3 clock to divide-by-5 clock and finally to divide-by-2 clock. The control signal encodes the selected clock division ratio. For each transition, the clock selection controlling clock gate logic enables only the appropriate sub-divider while disabling others, ensuring that only the desired output clock is propagated. For example, the control signal with a value of 0 corresponds to the high-speed input clock is propagating to the output of the clock generator. When the control signal is 4, the gating logic ungates the divide-by-1p5 sub-divider, when the control signal is 5, the gating logic ungates the divide-by-3 sub-divider, when the control signal is 6, the gating logic ungates the divide-by-5 sub-divider exclusively. The shared sub-divider may produce multiple clocks when ungated, for example, the shared sub-divider is ungated when the control signals is 1, 2, or 3 as the control signal equals to 1 corresponding to a divide-by-2 clock enabling, the control signal equals to 2 corresponding to a divide-by-4 clock enabling, and the control signal equals to 3 corresponding to a divide-by-8 clock enabling.

Initially, the control signal is updated to select the divide-by-1p5 clock. In response, the clock selection controlling clock gate logic enables the divide-by-1p5 sub-divider by asserting the corresponding clock enable pin (i.e., the selection signal) high, based on the internal states of the glitch-free multiplexers. As a result, the divide-by-1p5 clock is propagated as the active clock, while all other sub-dividers are gated by setting the corresponding clock enable pins low. This gating mechanism halts toggling of the unused sub-dividers at the high-speed input clock. During clock switching, there may be intervals in which the control signal is set to 0, in this state, the clock selection controlling clock gate logic gates the currently active sub-divider, thereby temporarily ceasing propagation of any divided clock to the output clock. Subsequently, the control signal transitions to select the divide-by-3 clock. In response, the clock selection controlling clock gate logic enables the divide-by-3 sub-divider by asserting the corresponding clock enable pin high, resulting in the divide-by-3 clock becoming active, while other divided clocks remain inactive. The control signal is then updated to select the divide-by-5 clock. The clock selection controlling clock gate logic enables the divde-by-5 sub-divider by asserting the corresponding clock enable pin high, thereby propagating the divde-by-5 clock to the output clock while gating all other sub-dividers by de-asserting their respective clock enable pins. Finally, the control signal transitions to select the divide-by-2 clock. In response, the clock selection controlling clock gate logic ungates the shared sub-divider by asserting the clock enable pin high. Since the sub-divider for the divide-by-2 clock is shared with the divide-by-4 and divide-by-8 clocks, all three clocks become active when the shared sub-divider is ungated.

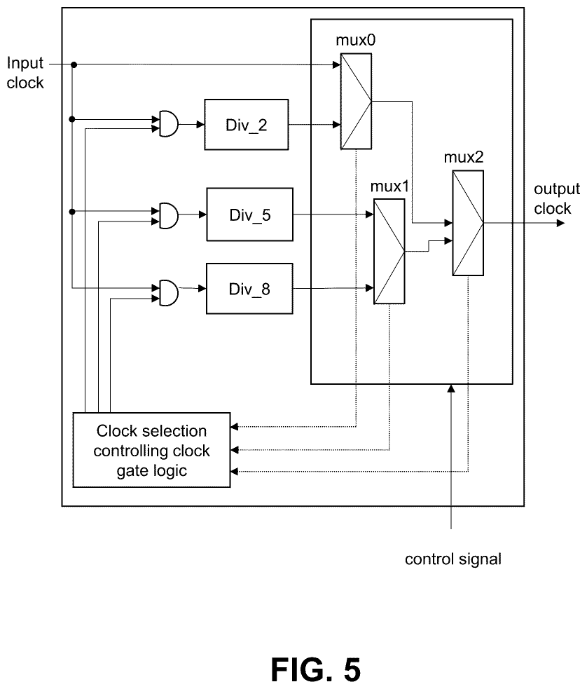

FIG. 5 is another embodiment of a clock generator with built-in clock gating logic. There are three sub-dividers in this clock generator, including a first sub-divider Div_2 divides an input clock by two to generate a divide-by-2 clock, a second sub-divider Div_5 divides the input clock by five to generate a divide-by-5 clock, and a third sub-divider Div_8 divides the input clock by eight to generate a divide-by-8 clock. The clock generator includes a set of multiplexers coupled to the sub-dividers to receive these divided clocks as well as the input clock and a control signal. The set of multiplexers produces an output clock which is a selected clock determined by the control signal. Each multiplexer is arranged to receive two input clocks and generate one output clock according to a select signal. The select signals are determined based on the control signal. Each of the set of multiplexers further outputs two internal states indicating the input clocks being active or inactive according to embodiments of the present invention. The two input clocks of each multiplexer are selecting from the input clock, the divided clocks output from the sub-dividers, and the output clocks of other multiplexer. In this embodiment, the multiplexer mux0 receives the input clock and the divide-by-2 clock, the multiplexer mux1 receives the divide-by-5 clock and divide-by-8 clock, and the multiplexer mux2 receives the output clocks of multiplexers mux0 and mux1. The clock generator includes a clock selection controlling clock gate logic receiving the internal states from the set of multiplexers and generating selection signals for the sub-dividers according to these internal states. Each of the sub-divider is ungated or gated depending on the corresponding selection signal output from the clock selection controlling clock gate logic.

Although the invention is illustrated and described herein with reference to specific embodiments, the invention is not intended to be limited to the details shown. Rather, various modifications may be made in the details within the scope and range of equivalents of the claims and without departing from the invention. It is to be understood that the above description is illustrative of the invention and is not to be construed as limiting the invention. Various modifications, applications and/or combinations of the embodiments may occur to those skilled in the art without departing from the scope of the invention as defined by the claims. Well-known circuits, processes, algorithms, structures, and techniques may be shown without unnecessary detail to avoid obscuring the aspects.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks may be stored in a computer-readable or machine-readable medium. The computer-readable medium may comprise memory or data storage media, such as Random-Access Memory (RAM) such as Synchronous Dynamic Random-Access Memory (SDRAM), Read-Only Memory (ROM), Non-Volatile Random-Access Memory (NVRAM), Electrically Erasable Programmable Read-Only Memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves. The program code may be executed by a processor, which may include one or more processors, such as one or more Digital Signal Processors (DSPs), general purpose microprocessors, an Application Specific Integrated Circuits (ASICs), Field Programmable Logic Arrays (FPGAs), or other equivalent integrated or discrete logic circuitry. Such a processor may be configured to perform any of the steps described in this disclosure. A general-purpose processor may be a microprocessor; alternatively, the processor may be any conventional processor, controller, microcontroller, or state machine. A processor may also be implemented as a combination of computing devices.

To clearly illustrate the interchangeability of hardware and software, various illustrative components, blocks, modules, engines, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present application.

What is claimed is:

1. A clock generator with built-in clock gating logic, comprising:
a plurality of sub-dividers, receiving and dividing an input clock of the clock generator to generate a plurality of divided clocks;
a plurality of multiplexers, receiving a control signal and coupled to the sub-dividers to receive the divided clocks, outputting a selected clock according to the control signal as an output clock of the clock generator, wherein each multiplexer is arranged to receive two input clocks and generate one output clock according to a select signal, and each multiplexer outputs internal states indicating the input clocks being active or inactive, wherein the two input clocks of each multiplexer are selecting from the input clock of the clock generator, the divided clocks output from the sub-dividers, and the output clocks of other multiplexers; and
a clock selection controlling clock gate logic, receiving the internal states from the multiplexers and generating selection signals for the sub-dividers according to the internal states;
wherein each of the sub-dividers is ungated or gated depending on the corresponding selection signal output from the clock selection controlling clock gate logic.

2. The clock generator of claim 1, wherein the input clock of each multiplexer is active when the input clock is being selected by the select signal to propagate to the output clock of the multiplexer.

3. The clock generator of claim 1, wherein the select signal for controlling each of the multiplexers is derived from the control signal, and the control signal determines the select signal for each multiplexer to propagate the selected clock from the sub-divider to the output clock.

4. The clock generator of claim 1, wherein each of the multiplexers comprises a double synchronizer, allowing switching between two asynchronous or synchronous input clocks without glitches.

5. The clock generator of claim 4, wherein the double synchronizer comprises two stages of flip flops.

6. The clock generator of claim 1, wherein one or more of the sub-dividers is configured to generate multiple divided clocks based on multiple predefined division rates.

7. The clock generator of claim 6, wherein the clock selection controlling clock gate logic generates a selection signal for each of the divided clocks sharing the same sub-divider.

8. The clock generator of claim 7, wherein the shared sub-divider is gated or ungated according to a logically combined selection signal derived from the selection signals.

9. The clock generator of claim 6, wherein the clock selection controlling clock gate logic generates a selection signal for the multiple divided clocks sharing the same sub-divider.

10. The clock generator of claim 1, wherein the clock selection controlling clock gate logic receives the internal states output from one of the multiplexers indicating a first input clock is being active while the second input clock is being inactive, and the clock selection controlling clock gate logic generates a selection signal to gate the sub-divider generating the second input clock and generates a selection signal to ungate the sub-divider generating the first input clock.

11. The clock generator of claim 1, wherein the clock selection controlling clock gate logic generates a selection signal to ungate the sub-dividers generating the selected clock when the received internal states indicate the corresponding input clock of every multiplexer needed for propagating the selected clock is active.

12. The clock generator of claim 1, wherein the clock selection controlling clock gate logic generates a selection signal to gate one of the sub-dividers generating a divided clock when the received internal states indicate any input clock of the multiplexer needed for propagating the divided clock is inactive.

13. The clock generator of claim 1, wherein the clock selection controlling clock gate logic ungates one or more sub-dividers according to the internal states during a transition period of clock switching initiated according to the control signal, wherein the output clock of the clock generator is a new selected clock after the transition period of clock switching.

14. The clock generator of claim 13, wherein the output clock of the clock generator is temporarily halted during the transition period of clock switching.

15. The clock generator of claim 13, wherein the clock selection controlling clock gate logic only ungates the sub-divider generating the new selected clock while gating all other sub-dividers after the transition period of clock switching.

16. The clock generator of claim 15, wherein the clock selection controlling clock gate logic ungates multiple sub-dividers to enable multiple divided clocks and gates all other sub-dividers to disable corresponding divided clocks during the transition period of clock switching.

17. The clock generator of claim 1, wherein the input clock of the clock generator is a high-speed clock generated by a Phase Locked Loop (PLL), and the output clock of the clock generator is a clock source for a digital module.

18. A clock generating method with clock gating for a digital circuit, comprising:
receiving an input clock and a control signal;
dividing the input clock by a first sub-divider of a plurality of sub-dividers to generate a selected clock determined by the control signal;
propagating the selected clock through one or more multiplexers to output the selected clock, wherein the one or more multiplexers is controlled by the control signal;
determining one or more selection signals for the sub-dividers according to internal states of the one or more multiplexers, wherein the internal states of the one or more multiplexer indicate input clocks of the one or more multiplexers being active or inactive; and
ungating the first sub-divider generating the selected clock while gating all other sub-dividers according to the one or more selection signals.

19. The clock generating method of claim 18, further comprising:
dividing the input clock by a second sub-divider of the plurality of sub-dividers to generate a new selected clock;
controlling the one or more multiplexers to propagate the new selected clock when the control signal indicates switching to the new selected clock;
determining the one or more selection signals for the sub-dividers according to updated internal states of the one or more multiplexers;
ungating more than one sub-divider according to the updated internal states of the one or more multiplexers during a transition period of clock switching; and
ungating only the second sub-divider while gating all other sub-dividers after the transition period of clock switching.

20. The clock generating method of claim 19, further comprising halting output of any clock during the transition period of clock switching.
